(19) United States
(12) Patent Application Publication
(10) Pub. No.: US 2026/0099156 A1
(43) Pub. Date: Apr. 9, 2026

(54) AUTOMATED MOTION SYSTEMS INTEGRATION

(71) Applicants: Sony Group Corporation, Tokyo (JP); Sony Pictures Entertainment Inc., Culver City, CA (US)

(72) Inventors: Jason Elbourne, Belleville (CA); Mahmoud Rahnama, Toronto (CA); Bryan Howard, Burlington (CA)

(21) Appl. No.: 19/274,103

(22) Filed: Jul. 18, 2025

Related U.S. Application Data
(60) Provisional application No. 63/704,413, filed on Oct. 7, 2024.

(51) Int. Cl. G05D 1/689; G03B 17/56; G05D 105/65

(52) U.S. Cl. CPC G05D 1/6895; G03B 17/561; G05D 2105/65

(57) ABSTRACT

Motion control integration including: a centralized integration system including data storage, a user interface, and multiple network connections; a first motion platform connected to the centralized integration system; a second motion platform connected to the centralized integration system; and a shared clock, where the centralized integration system shares clock data with the first motion platform and the second motion platform.

### CROSS-REFERENCE TO RELATED APPLICATIONS

This application claims the benefit of priority under 35 U.S.C. § 119(e) of co-pending U.S. Provisional Ser. No. 63/704,413 , filed Oct. 7, 2024, entitled “Automated Motion Systems Integration”. The disclosure of the above-referenced application is incorporated herein by reference.

### BACKGROUND

### Field

The present disclosure relates to motion control integration, and more specifically to motion control integration of motion platforms.

### Background

In a conventional system with motion platforms, similar motion platforms are typically operated and controlled using platform's embedded controls which are isolated and independent from any other motion platforms in the system.

For example, a programmable camera crane system may create or edit its own moves and be triggered to play back or stop those moves within the crane's embedded system. It would typically not be triggered to start or stop along with a separate vehicle motion platform. The vehicle motion platform may also program its own moves and be triggered to play back or edit those moves within the vehicle motion platform's embedded system. The two systems (i.e., the camera crane system and the vehicle motion platform), although similar in use, would operate and function independent of one another.

In another example, the programing of move data (i.e., animation) for each motion platform is either saved or backed from the embedded system itself or loaded onto individual systems in some cases with a proprietary file format and move protocol. This data is not typically shared with the other platforms or stored in common or compatible format.

### SUMMARY

In one implementation, a system for motion control integration is disclosed. The system includes: a centralized integration system including data storage, a user interface, and multiple network connections; a first motion platform connected to the centralized integration system; a second motion platform connected to the centralized integration system; and a shared clock, where the centralized integration system shares clock data with the first motion platform and the second motion platform.

In another implementation, a method of motion control integration for a plurality of motion platforms is disclosed. The method includes: generating a command which operates to establish connections among the plurality of motion platforms; establishing the connections among the plurality of motion platforms including at least a vehicle motion platform and a programmable camera crane; submitting and checking move data for each motion platform to determine whether the platform can physically perform the animated move specified in the move data; determining output of the check move data to be either valid or invalid; disabling or enabling a move operation depending on the output being invalid or valid, respectively, wherein the move operation proceeds to a motion control state to enable control of the plurality of motion platforms.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 shows a user interface order of operation of a system for motion control integration in accordance with one implementation of the present disclosure;

FIG. 2 shows shared move state determination of the motion control state in accordance with one example implementation of the present disclosure;

FIG. 3 shows a synchronizing command operation of the motion control state of a system in accordance with one example implementation of the present disclosure;

FIG. 4 shows communication over TCP showing flow of requests and responses to and from client and server devices in a system for motion control integration in accordance with one implementation of the present disclosure;

FIG. 5 is a diagram showing move ranges of motion platforms including partial moves and full move in accordance with one implementation of the present disclosure;

FIG. 6 is a flow diagram of a method for motion control integration in accordance with one implementation of the present disclosure; and

FIG. 7 is a block diagram of a system for motion control integration in accordance with one implementation of the present disclosure.

### DETAILED DESCRIPTION

As described above, in a conventional system with motion platforms, similar motion platforms are typically operated and controlled using platform's embedded controls which are isolated and independent from any other motion platforms in the system.

Certain implementations of the present disclosure provide for apparatus and methods to implement a technique for integrating automated motion systems or platforms.

After reading below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

In one implementation, a technique for integrating automated motion systems is disclosed. Each of the automated motion system includes a plurality of large hardware devices and a client tool. In one implementation, the integration process involves tightly connecting the hardware devices to the client tool, ensuring seamless communication. In one implementation, the hardware devices utilize a similar protocol (e.g., over Transmission Control Protocol (TCP)) and exchange information using a file format and markup language (e.g., Extensible Markup Language (XML)) that allows users to store, transmit, and reconstruct data. The logic of the client tool is dependent on the combined state of the connected hardware. A shared control protocol effectively drives the two or more dissimilar motion systems, allowing them to operate in harmony.

Features provided in implementations can include, but are not limited to, one or more of the following items:

(1) Multiple motion systems, such as vehicle motion platforms, camera cranes, and other similarly-configured systems such as driving simulators;

(2) Software and hardware integration systems for communication between the motion systems to transform the communicated data into a common protocol or language;

(3) A shared data structure across two or more motion platforms;

(4) Submitting move commands to a plurality of motion platforms that start or trigger at the same time with a shared clock to solve latency between hardware motion;

(5) Dead-man switches or stops with shared functionality between all connected motion platforms;

(6) Loading ‘move’ data across all motion platforms on the system in one command from a centralized integration system;

(7) Synchronizing the start and stop of a programmed ‘move’ across all motion platforms using a future time and a shared time code;

(8) Using a shared dead-man switch signal to stop all motion platforms on the system when a single dead-man switch is released; and

(9) Triggering an emergency stop (e-stop) across all motion platforms on the system when a single e-stop switch is triggered.

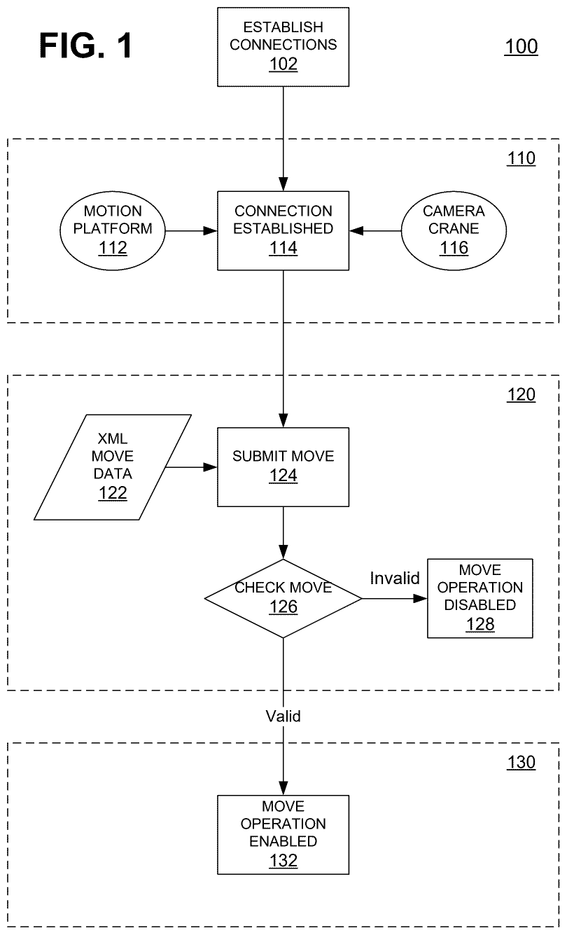

FIG. 1 shows a user interface order of operation of a system 100 for motion control integration in accordance with one implementation of the present disclosure. In one implementation, the user interface operation includes a settings state 110, a move input/output (I/O) state 120, and a motion control state 130.

In one implementation, the system 100 initially generates a command 102 which operate to establish connections among a plurality of motion platforms 112, 116. The system 100 may include a networked computer system connected to each motion platform, providing a centralized integration system. In one implementation, the system: (a) provides a user interface for operator interaction, such as a graphical user interface (GUI); (b) uses transmission control protocol (TCP) socket connections; (c) includes a shared clock connected to each platform; and (d) includes or is connected to a light-emitting diode (LED) sound stage with virtual content.

Thus, the system 100 provides integration and control across the connected platforms.

In one implementation, the settings state 110 establishes connections 114 among a plurality of motion platforms 112, 116 including at least a vehicle motion platform 112 and a programmable camera crane 116.

In one implementation, the move I/O state 120 submits moves 124 that each individual platform will be executing. In one implementation, move data for each platform is submitted in XML move data 122. The move data 122 is then checked (at step 126) to determine whether the platform can physically perform the animated move specified in the move data 122. For example, the move data 122 is checked to determine whether the platform can physically move as fast or as far as specified in the move data 122. The output of the check move data step 126 is either valid or invalid. Thus, if the output is invalid, then the move operation is disabled 128. Otherwise, if the output is valid, then the move operation is enabled 132 and the operation moves to the motion control state 130 to enable the ability to control the plurality of control platforms 112, 116.

In one example of aspects of operation, the system 100 provides connections integration. From the centralized integration system, a user may connect multiple motion platforms to the system, wherein each motion platform may have different actuation and/or degrees-of-freedom mechanisms. The centralized integration system provides TCP communication for reliability between all motion platforms on the system. Using an IP address and port, the centralized integration system sends a connection signal to all requested motion platforms, and listens for a success, error, or timeout response. A user can verify what devices have successfully connected and any error messages for connections that were not established, using the centralized integration system user interface. If motion platforms are successfully connected, the user may then integrate motion instructions for all motion platforms into one move structure/file and begin to send ‘move’data to those platforms.

In another example of aspects of operation, the system 100 provides move integration. From the centralized integration system, a user may submit ‘move’ data to multiple motion platforms. In one implementation, the ‘move’ data is an XML-based collection of move metadata and a list of animation frames (or other markers in content) including properties associated with the motion platform for which the move is intended. Each frame represents a set of parameters associated with a specific moment in the movement data. Collectively, the ‘move’ data may include all moves for each connected motion platform. Unique root elements, referencing the motion platform identifier, may be used to encapsulate the ‘move’ data so the hardware may filter out commands not directed to itself. Also, the TCP communication may then be used to submit the ‘move’ data and listen for a success, error, or timeout response. A successful connection may return data identifying whether the ‘move’ was a valid move and the motion platform may execute the requested maneuver. The user may also verify what ‘moves’ are valid on the connected motion platforms and any error messages for invalid ‘moves', using the user interface of the centralized integration system. If a 'move’ 1s valid across all connected motion platforms, the user may begin the process of controlling the motion platforms. A valid move is one that stays within the physical limits of the motion platform or camera crane, including its range of movement, speed, and acceleration. An invalid move exceeds those limits, such as attempting an animation that pushes the platform or crane beyond its allowed position or acceleration thresholds.

In yet another example of aspects of operation, the system provides control integration. Using the centralized integration system user interface, the user may send commands to all connected motion platforms. The system may then provide shared commands where possible between multiple motion platforms to reduce complexity. In one implementation, a shared command is mapped to the proprietary or embedded commands of each motion platform. The user may also select the valid move to be executed from a list of valid moves. The user may then start, stop, and set the move speed for a selected move. In one implementation, the commands that are sensitive to time synchronization, such as start and stop commands, receive a future time (e.g., approximately one second in the future) before the commands are initiated. This enables synchronized actions using shared clocks between all motion platforms. Both the start and stop commands for the platforms may be initiated at the same time and may be at a certain programmed time.

In yet another example of aspects of operation, the system provides synchronization of the integration.

All motion platforms when working together may work in unison. In one implementation, the unified operation is verified and maintained as a requirement for operation.

All hardware interfaces work with a shared clock signal used to synchronize the motions of the hardware. Commands to the hardware that directly control the motion of the hardware are given a future time (e.g., one second in the future) to initiate a motion. Combined with the shared clock, the hardware moves may occur in unison instead of delayed by sequentially initiating a command. This may be used to counteract any latency in the network system connecting all motion platforms. In one implementation, the unified motion and operation of the platforms is monitored and measured.

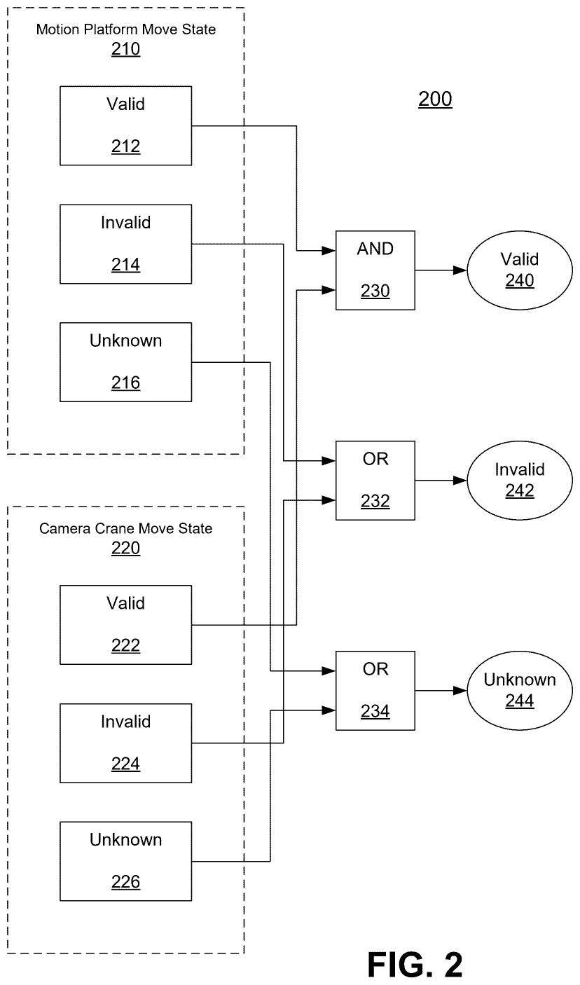

FIG. 2 shows shared move state determination 200 of the motion control state 130 in accordance with one example implementation of the present disclosure. In the illustrated implementation of FIG. 2, the shared move state determination 200 is made with one vehicle motion platform (with move state 210) and one camera crane (with move state 220). In this example, both the vehicle motion platform move state 210 and the camera crane move state 220 must be determined to be in valid states 212, 222 (by logic 230) to declare the shared move state as being valid 240. If either the vehicle motion platform move state 210 or the camera crane move state 220 is determined to be in an invalid state 214, 224 (by logic 232), then the shared move state is declared as being invalid 242. Further, if either the vehicle motion platform move state 210 or the camera crane move state 220 is determined to be in an unknown state 216, 226 (by logic 234), then the shared move state is declared as being unknown 244. Each individual move state being in an unknown state 216, 226 refers to a state when the move data is initially submitted (step 124 in FIG. 1).

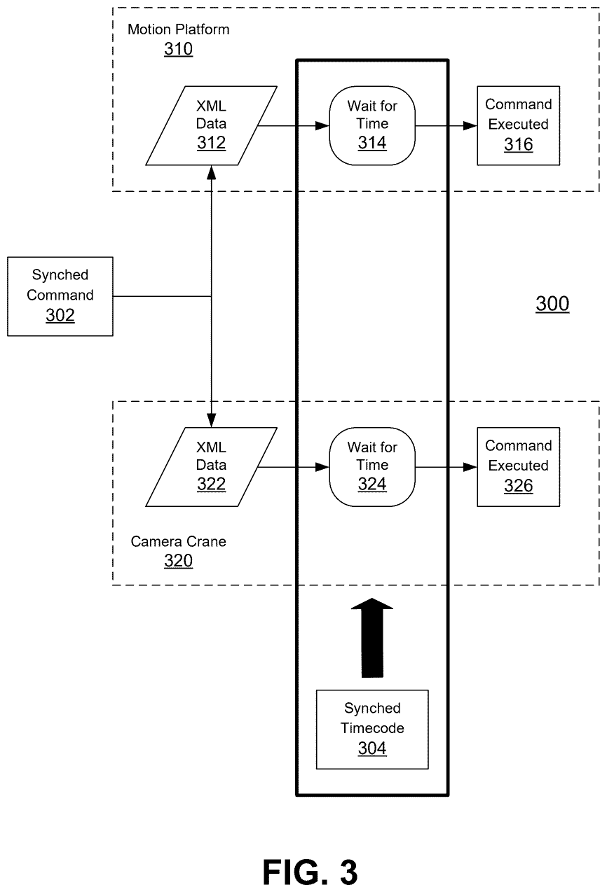

FIG. 3 shows a synchronizing command operation of the motion control state 130 of a system 300 in accordance with one example implementation of the present disclosure. In the illustrated implementation of FIG. 3, the synchronizing command operation is performed with one vehicle motion platform 310 and one camera crane 320. Once both the vehicle motion platform 310 and the camera crane 320 (collectively “motion platforms”) have received shared move states as being valid, the system 300 issues a synchronized command 302 to the XML data logics 312, 322 of the motion platforms 310, 320, respectively, to start the movement. To ensure that the motion platforms 310, 320 start the movement at the same time (i.e., substantially simultaneously), a synchronized timecode 304 with ‘wait-for-time’ parameters 314, 324 are sent to the motion platforms 310, 320, respectively. The ‘wait-for-time’ parameters 314, 324 build in time lags so that the motion platforms 310, 320 start the movement at a specific time in the future (e.g., one second) to account for any latency in the network to which the system 300 is connected.

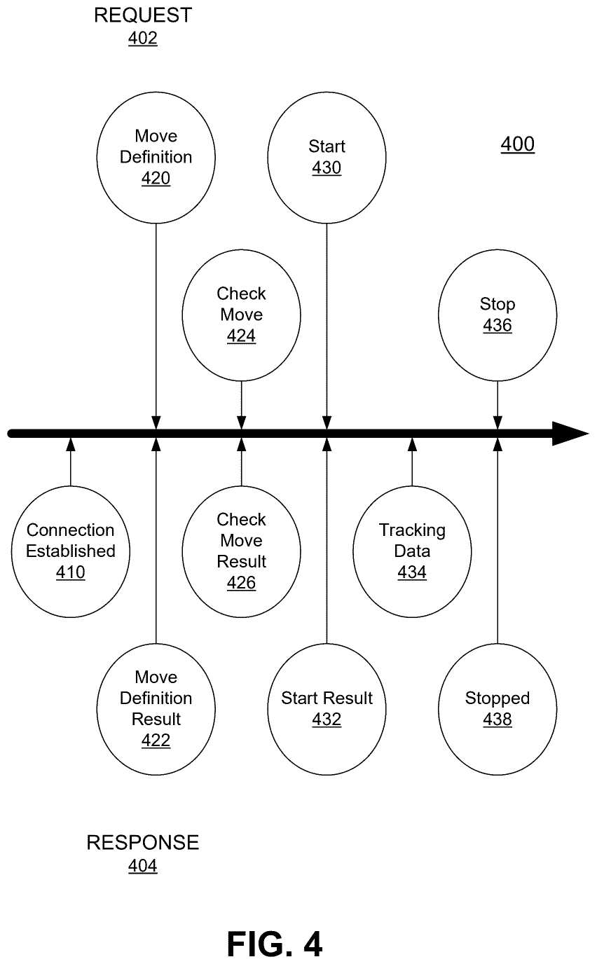

FIG. 4 shows communication over TCP showing flow of requests and responses to and from client and server devices in a system 400 for motion control integration in accordance with one implementation of the present disclosure. The illustrated implementation of FIG. 4 shows the flow of data and operation from the perspective of the TCP connection.

In comparing FIG. 4 to FIG. 1: (a) a connection is established at block 410 (like the settings state 110); (b) create move definition to send to the platforms at block 420, generate move definition result to determine whether the move definition was received at block 422, check move at block 424, and check move result to determine whether the move is valid at block 426 (like the move I/O state 120); and (c) start move command at block 430, start move result at block 432, get tracking data to determine the status of the platform movements at block 434, and stop/stopped the platforms once the move is done at blocks 436, 438 (like the motion control state 130).

The platforms may be stopped earlier if there were any emergency conditions that would require the platforms to stop prior to the end of the movements.

In one example of aspects of operation, the system provides a dead-man switch integration including a stop box. The stop box is a centralized box that interfaces directly with all motion platforms and is configured with a normal stop and an emergency stop (e-stop). Since moving systems have significant mass and/or momentum, the e-stop enables immediate stop for all motion platforms. In one implementation, the stop box manages the connection between multiple platforms on interfacing with the normal stop and the e-stops by accounting for ground loops and isolation between platforms. Thus, dead-man switches function as normal stops when the switches are let go with an optional e-stop latching button attached to them.

However, when a dead-man switch is connected to the stop box, the switch must be held down by a safety operator for the entire system to function. The dead-man switches trigger stops to all connected hardware (e.g., platforms) to the stop box.

In one example of aspects of operation, the system provides e stops for all the platforms (emergency stops). In one implementation, all motion platforms include dedicated latching e-stop directly connected to the main contactor energizing the platforms. Operator controls can have optional latching e-stop buttons which will trigger a global e-stop to all connecting hardware in case of emergencies.

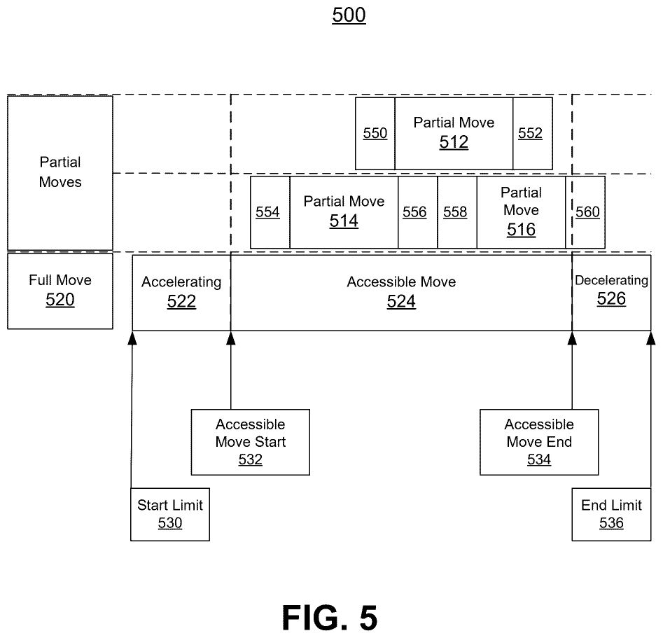

FIG. 5 is a diagram showing move ranges of motion platforms including partial moves 510 and full move 520 in accordance with one implementation of the present disclosure. In the illustrated implementation of FIG. 5, a valid move includes accelerating 522 and decelerating 526 ranges at the beginning (e.g., at the start limit 530) and the end (e.g., at the end limit 536), respectively.

Further, the accessible area (between accessible move start 532 and accessible move end 534) may be split into partial moves 512, 514, 516.

In one implementation, the full move 520 starts at a first stopped position (e.g., at the start limit 530) and ends at a second stopped position (e.g., at the end limit 536) with acceleration 522 and deceleration 526 added at the ends. The programmed range or distance of the acceleration 522 and the deceleration 526 is calculated based on the weight of the motion platform.

In one implementation, accelerations and decelerations are added to the partial moves 512, 514, 516. For example, acceleration 550 and deceleration 552 are added to the partial move 512, acceleration 554 and deceleration 556 are added to the partial move 514, and acceleration 558 and deceleration 560 are added to the partial move 516. In one implementation, the time length of each acceleration 550, 554, 558 and each deceleration depends on how fast the motion platform is moving, in which direction the motion platform is moving, and the mass of the motion platform including the weight of the actor on the motion platform.

One implementation includes one or more programmable processors and corresponding computer system components to store and execute computer instructions, such as to provide the communication and control across motion platforms, the user interface for control, and the storage, creation, and transfers of shared data and data structures.

Implementations of the system can include variations of the aspects described here as well. For example, the data structure used in the communication protocol could be written in JSON or comma separated values (CSV). The communication protocol in use could be User Datagram Protocol (UDP) and will be in some applications of this integration. The synchronization of the LED sound stage and two or more motion platforms can utilize timecode, genlock or frame lock. The system can be applied to various forms of content creation involving motion platforms, such as movies, television, games, music videos, or streaming or online content.

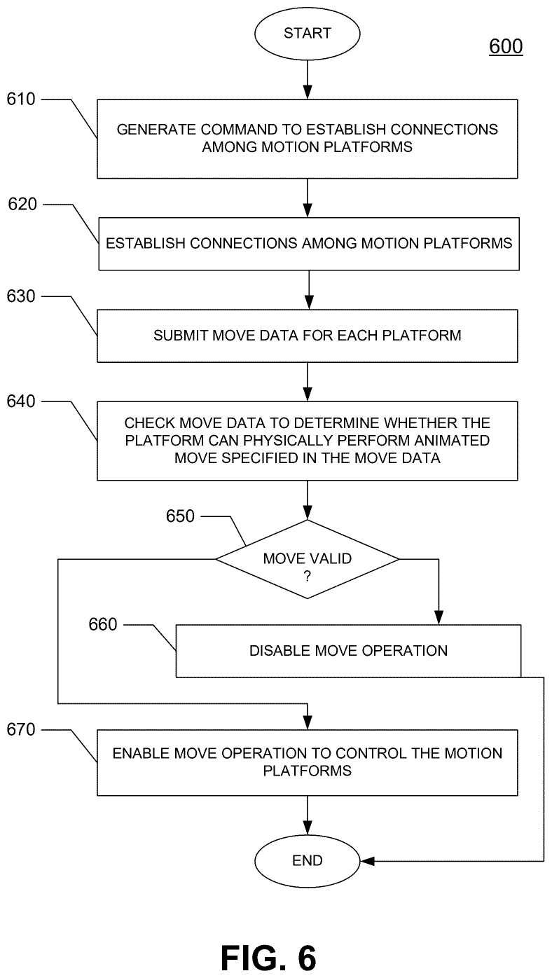

FIG. 6 is a flow diagram of a method 600 for motion control integration in accordance with one implementation of the present disclosure. In the illustrated implementation of FIG. 6, a command which operates to establish connections among a plurality of motion platforms is generated, at step 610. In One implementation, each motion platform is connected to a networked computer system to provide a centralized integration system. The connections are then established, at step 620, among the plurality of motion platforms including at least a vehicle motion platform and a programmable camera crane.

In one implementation, move data for each platform is submitted, at step 630, and checked, at step 640, to determine whether the platform can physically perform the animated move specified in the move data. For example, the move data is checked to determine whether the platform can physically move as fast or as far as specified in the move data. The output of the check move data step 640 is determined, at step 650, to be either valid or invalid.

Thus, if the output is determined to be invalid, then the move operation is disabled, at step 660. Otherwise, if the output is valid, then the move operation is enabled, at box 670, and the operation moves to a motion control state to enable the ability to control the plurality of motion platforms.

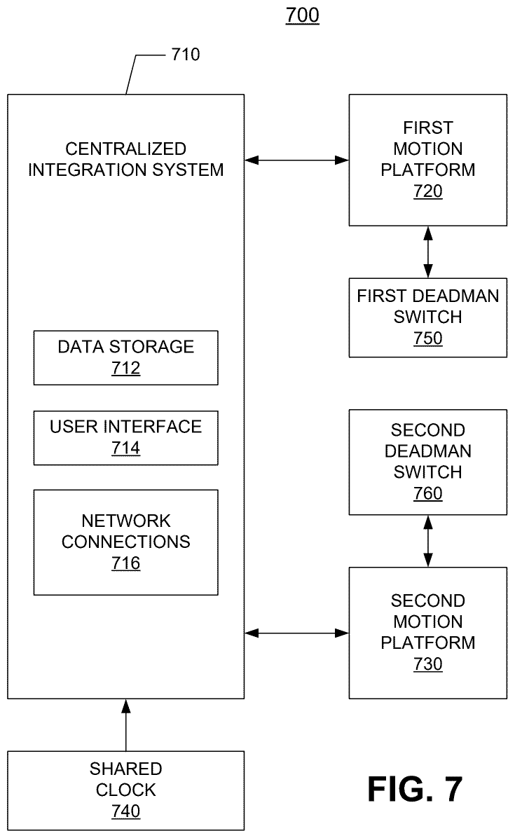

FIG. 7 is a block diagram of a system 700 for motion control integration in accordance with one implementation of the present disclosure. In the illustrated implementation of FIG. 7, the system 700 includes a centralized integration system 710, a first motion platform 720, a second motion platform 730, and a shared clock 740. In one implementation, the system 700 also includes a first dead-man switch 750 and a second dead-man switch 760.

In one implementation, the centralized integration system 710 includes data storage 712, a user interface 714, and multiple network connections 716. Further, the first motion platform 720 and the second motion platform 730 connect to the centralized integration system 710. In one implementation, the centralized integration system 710 loads move data across all motion platforms, including the first motion platform 720 and the second motion platform 730, with one command. In one implementation, the shared clock 740 enables the centralized integration system 710 to share clock data with the first motion platform 720 and the second motion platform 730. In one implementation, the centralized integration system 710 synchronizes the start and stop of a programmed move across all motion platforms, including the first motion platform 720 and the second motion platform 730, using a future time and a shared time code.

In one implementation, the first dead-man switch 750 connects to the first motion platform 720, while the second dead-man switch 760 connects to the second motion platform 730, where the centralized integration system 710 creates a shared dead-man switch signal to stop both the first motion platform 720 and the second motion platform 730.

In a particular implementation, a system for motion control integration is disclosed. The system includes: a centralized integration system including data storage, a user interface, and multiple network connections; a first motion platform connected to the centralized integration system; a second motion platform connected to the centralized integration system; and a shared clock, where the centralized integration system shares clock data with the first motion platform and the second motion platform.

In one implementation, the system further includes a first dead-man switch connected to the first motion platform; a second dead-man switch connected to the second motion platform; where the centralized integration system creates a shared dead-man switch signal to stop both the first motion platform and the second motion platform. In one implementation, the centralized integration system loads move data across all motion platforms, including the first motion platform and the second motion platform, with one command. In one implementation, the centralized integration system synchronizes the start and stop of a programmed move across all motion platforms, including the first motion platform and the second motion platform, using a future time and a shared time code.

In another particular implementation, a method of motion control integration for a plurality of motion platforms is disclosed. The method includes: generating a command which operates to establish connections among the plurality of motion platforms; establishing the connections among the plurality of motion platforms including at least a vehicle motion platform and a programmable camera crane; submitting and checking move data for each motion platform to determine whether the platform can physically perform the animated move specified in the move data; determining output of the check move data to be either valid or invalid; disabling or enabling a move operation depending on the output being invalid or valid, respectively, wherein the move operation proceeds to a motion control state to enable control of the plurality of motion platforms.

In one implementation, each motion platform is connected to a networked computer system to provide motion control integration. In one implementation, checking the move data includes determining whether each motion platform can physically move as fast or as far as specified in the move data. In one implementation, the move data includes an XML-based collection of move metadata and a list of animation frames. In one implementation, the list of animation frames includes properties associated with each motion platform for which the move operation is intended. In one implementation, each animation frame represents a set of parameters associated with a specific moment in the move data. In one implementation, the move data includes all moves for each motion platform. In one implementation, the method further includes encapsulating the move data using unique root elements referencing an identifier of each motion platform to filter out commands not directed to each motion platform. In one implementation, submitting the move data comprises using the TCP communication to submit and listen for a success, error, or timeout response. In one implementation, the success response returns data identifying whether the move data was a valid move or invalid move and each motion platform executes requested move. In one implementation, a valid move is a move that stays within physical limits of each motion platform including its range of movement, speed, and acceleration. In one implementation, an invalid move is a move which exceeds the physical limits of each motion platform. In one implementation, the method further includes: selecting the valid move to be executed from a list of valid moves; and commanding to start, stop, and set a speed for the selected move. In one implementation, start and stop commands receive a future time before the commands are initiated. In one implementation, the method further includes transmitting commands to all connected motion platforms; and providing shared commands between the connected motion platforms to reduce complexity. In one implementation, the shared commands are mapped to embedded commands of each motion platform.

The description herein of the disclosed implementations is provided to enable any person skilled in the art to make or use the present disclosure. Numerous modifications to these implementations would be readily apparent to those skilled in the art, and the principals defined herein can be applied to other implementations without departing from the spirit or scope of the present disclosure. Thus, the present disclosure is not intended to be limited to the implementations shown herein but is to be accorded the widest scope consistent with the principal and novel features disclosed herein.

Various implementations of the present disclosure are realized in electronic hardware, computer software, or combinations of these technologies. Some implementations include one or more computer programs executed by one or more computing devices. In general, the computing device includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., game controllers, mice and keyboards), and one or more output devices (e.g., display devices).

The computer programs include executable code that is usually stored in a persistent storage medium and then copied into memory at run-time. At least one processor executes the code by retrieving program instructions from memory in a prescribed order. When executing the program code, the computer receives data from the input and/or storage devices, performs operations on the data, and then delivers the resulting data to the output and/or storage devices.

Those of skill in the art will appreciate that the various illustrative modules and method steps described herein can be implemented as electronic hardware, software, firmware or combinations of the foregoing. To clearly illustrate this interchangeability of hardware and software, various illustrative modules and method steps have been described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the present disclosure. In addition, the grouping of functions within a module or step is for ease of description. Specific functions can be moved from one module or step to another without departing from the present disclosure.

All features of each above-discussed example are not necessarily required in a particular implementation of the present disclosure. Further, it is to be understood that the description and drawings presented herein are representative of the subject matter that is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A system for motion control integration, compr1s1ng:
a centralized integration system including data storage, a user interface, and multiple network connections;
a first motion platform connected to the centralized integration system;
a second motion platform connected to the centralized integration system; and
a shared clock, where the centralized integration system shares clock data with the first motion platform and the second motion platform.

2. The system of claim 1, further compr1s1ng:
a first dead-man switch connected to the first motion platform;
a second dead-man switch connected to the second motion platform;
where the centralized integration system creates a shared dead-man switch signal to stop both the first motion platform and the second motion platform.

3. The system of claim 1, where the centralized integration system loads move data across all motion platforms, including the first motion platform and the second motion platform, with one command.

4. The system of claim 1, where the centralized integration system synchronizes the start and stop of a programmed move across all motion platforms, including the first motion platform and the second motion platform, using a future time and a shared time code.

5. A method of motion control integration for a plurality of motion platforms, the method comprising:
generating a command which operates to establish connections among the plurality of motion platforms;
establishing the connections among the plurality of motion platforms including at least a vehicle motion platform and a programmable camera crane;
submitting and checking move data for each motion platform to determine whether the platform can physically perform the animated move specified in the move data;
determining output of the check move data to be either valid or invalid;
disabling or enabling a move operation depending on the output being invalid or valid, respectively,
wherein the move operation proceeds to a motion control state to enable control of the plurality of motion platforms.

6. The method of claim 5, wherein each motion platform is connected to a networked computer system to provide motion control integration.

7. The method of claim 5, wherein checking the move data comprises determining whether each motion platform can physically move as fast or as far as specified in the move data.

8. The method of claim 5, wherein the move data includes an XML-based collection of move metadata and a list of animation frames.

9. The method of claim 8, wherein the list of animation frames includes properties associated with each motion platform for which the move operation is intended.

10. The method of claim 8, wherein each animation frame represents a set of parameters associated with a specific moment in the move data.

11. The method of claim 5, wherein the move data includes all moves for each motion platform.

12. The method of claim 5, further comprising
encapsulating the move data using unique root elements referencing an identifier of each motion platform to filter out commands not directed to each motion platform.

13. The method of claim 5, wherein submitting the move data comprises using the TCP communication to submit and listen for a success, error, or timeout response.

14. The method of claim 13, wherein the success response returns data identifying whether the move data was a valid move or invalid move and each motion platform executes requested move.

15. The method of claim 14, wherein a valid move is a move that stays within physical limits of each motion platform including its range of movement, speed, and acceleration.

16. The method of claim 15, wherein an invalid move is a move which exceeds the physical limits of each motion platform.

17. The method of claim 14, further comprising:
selecting the valid move to be executed from a list of valid moves; and
commanding to start, stop, and set a speed for the selected move.

18. The method of claim 17, wherein start and stop commands receive a future time before the commands are initiated.

19. The method of claim 5, further comprising:
transmitting commands to all connected motion platforms; and
providing shared commands between the connected motion platforms to reduce complexity.

20. The method of claim 19, wherein the shared commands are mapped to embedded commands of each motion platform.
